(19) United States
(12) Patent Application Publication
(10) Pub. No.: US 2018/0277946 A1
(43) Pub. Date: Sep. 27, 2018

(54) ANTENNA APPARATUS

(71) Applicant: Panasonic Corporation, Osaka (JP)

(72) Inventors: TOMOHIRO MURATA, Kanagawa (JP); JUNJI SATO, Tokyo (JP)

(21) Appl. No.: 15/926,630

(22) Filed: Mar. 20, 2018

(30) Foreign Application Priority Data
Mar. 24, 2017 (JP) 2017-059191

(51) Int. Cl. H01Q 1/52; H01Q 19/185; H01Q 1/48

(52) U.S. Cl. CPC H01Q 1/521; H01Q 1/48; H01Q 19/185

(57) ABSTRACT

An antenna apparatus includes: a dielectric substrate; at least first and second radiators disposed in a first wiring layer in the dielectric substrate; a first reflector disposed in a first range in a second wiring layer in the dielectric substrate, the first range including a second range where the first radiator is projected in the layer thickness direction of the dielectric substrate; a second reflector disposed in a third range in the second wiring layer, the third range including a fourth range where the second radiator is projected in the layer thickness direction; and an electromagnetic band-gap disposed between the first and second radiators. The electromagnetic band-gap has patches disposed in the first wiring layer, a ground electrode disposed in a third wiring layer at a different place from the second wiring layer in the layer thickness direction, and a first via extending in the layer thickness direction, both ends of the via mutually connecting the patches and ground electrode.

### BACKGROUND

### 1. Technical Field

The present disclosure relates to an antenna apparatus.

### 2. Description of the Related Art

With a small transmission and reception module for the use of wireless communication, a plurality of antennas are disposed in a single substrate. When a plurality of antennas are disposed closely to each other in a single substrate, a signal leak occurs due to mutual coupling between antennas.

In an example of suppressing mutual coupling between two antennas in a substrate, an electromagnetic band-gap is disposed between the two antennas. Such an example is disclosed in Fan Yang, Yahya Rahmat-Samii, “Microstrip Antennas Integrated with Electromagnetic Band-Gap (EBG) Structures: A Low Mutual Coupling Design for Array Applications”, IEEE Transactions on Antennas and Propagation, vol. 51, No. 10, pp. 2936-2946, (Oct. 14, 2003).

### SUMMARY

However, when the EBG in the above disclosure is to be disposed in a substrate, the size of the EBG is determined depending on the parameters (such as, for example, the frequency of an electromagnetic wave to be radiated) of antennas disposed in that substrate. Therefore, the substrate including the EBG and antennas has a small number of degrees of freedom in design.

One non-limiting and exemplary embodiment facilitates providing an antenna apparatus that can have higher degrees of freedom in the design of a substrate including an EBG and antennas.

In one general aspect, the techniques disclosed here feature an antenna apparatus that includes: a dielectric substrate, at least a first radiator and a second radiator that are disposed in a first wiring layer included in the dielectric substrate, a first reflector disposed in a first range in a second wiring layer included in the dielectric substrate, the first range including a second range in which the first radiator is projected in the layer thickness direction of the dielectric substrate, a second reflector disposed in a third range in the second wiring layer, the third range including a fourth range in which the second radiator is projected in the layer thickness direction, and a first electromagnetic band-gap disposed between the first radiator and the second radiator. The first electromagnetic band-gap has first patches disposed in the first wiring layer, a first ground electrode disposed in a third wiring layer at a different place from the second wiring layer in the layer thickness direction of the dielectric substrate, and first vias extending in the layer thickness direction, both ends of the first via mutually connecting the first patches and the first ground electrode.

It should be noted that these comprehensive or specific aspects may be implemented as a system, a method, an integrated circuit, a computer program, a recording medium, or any selective combination thereof.

One aspect of the present disclosure contributes to the improvement of the number of degrees of freedom in the design of a substrate including an EBG and antennas.

Additional benefits and effects in one aspect of the present disclosure will become apparent from the specification and drawings. The benefits and/or effects may be individually obtained by some embodiments and features of the specification and drawings, which need not all be provided in order to obtain one or more of such benefits and/or effects.

### BRIEF DESCRIPTION OF THE DRAWINGS

FIG. 1 is a top view illustrating an example of a conventional antenna apparatus having an EBG;

FIG. 2 is a cross-sectional view taken along line II-II in FIG. 1;

FIG. 3 is a top view illustrating an example of an antenna apparatus according to a first embodiment of the present disclosure;

FIG. 4 is a cross-sectional view taken along line IV-IV in FIG. 3;

FIG. 5 is a cross-sectional view illustrating an example of an antenna apparatus having stack vias;

FIG. 6 is an enlarged view a unit cell in the EBG;

FIG. 7 illustrates an equivalent circuit of the unit cell in the EBG;

FIG. 8 illustrates a relationship between capacitance and distance;

FIG. 9 is a cross-sectional view of an antenna apparatus that lacks an EBG;

FIG. 10 illustrates the isolation characteristics of the antenna apparatus that lacks an EBG;

FIG. 11 illustrates the isolation characteristics of the conventional antenna apparatus having an EBG;

FIG. 12 illustrates the isolation characteristics of the antenna apparatus according to the first embodiment of the present disclosure;

FIG. 13 is a cross-sectional view illustrating an example of an antenna apparatus according to a variation of the first embodiment of the present disclosure;

FIG. 14 is a top view illustrating an example of an antenna apparatus according to a second embodiment of the present disclosure; and

FIG. 15 is a cross-sectional view taken along line XV-XV in FIG. 14.

### DETAILED DESCRIPTION

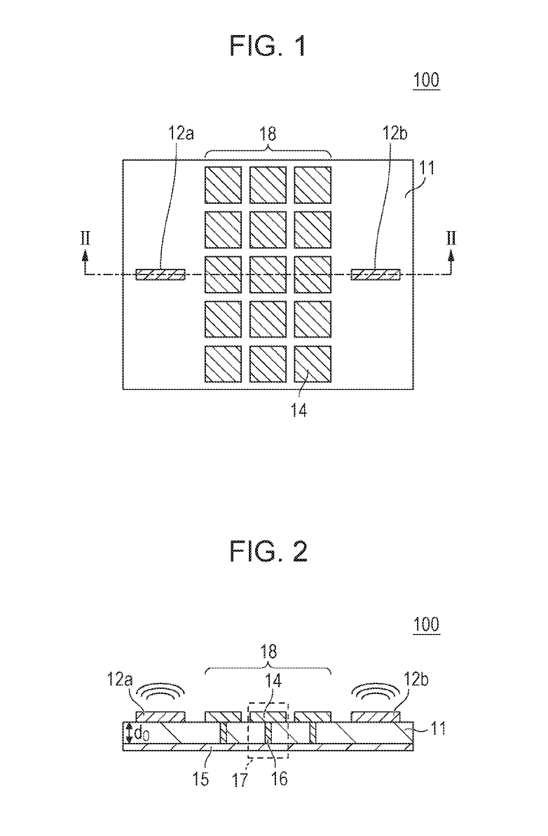

FIG. 1 is a top view illustrating an example of a conventional antenna apparatus 100 having an EBG. FIG. 2 is a cross-sectional view taken along line II-II in FIG. 1.

The antenna apparatus 100 has a dielectric substrate 11, a radiator 12a, a radiator 12b, a ground electrode 15, and an EBG 18.

The radiator 12a and radiator 12b are formed on the front surface of the dielectric substrate 11 by using conductive patterns.

The ground electrode 15 is formed on a surface opposite to the front surface of the dielectric substrate 11 by using a conductive pattern. The ground electrode 15 functions as a reflector that reflects electromagnetic waves radiated by the radiator 12a and radiator 12b. A combination of the radiator 12a and ground electrode 15 function as a single antenna, and a combination of the radiator 12b and ground electrode 15 also function as a single antenna.

The EBG 18 is disposed between the radiator 12a and the radiator 12b. The EBG 18 includes a plurality of patches 14 formed on its surface layer and a plurality of vias 16, each of which mutually connects one patch 14 and the ground electrode 15. The EBG 18 is formed by periodically placing unit cells 17, each of which is a combination of the ground electrode 15, one via 16 connected to the ground electrode 15, and the patch 14 corresponding to the via 16. Since the EBG 18 has an effect of blocking signals in a particular frequency band, the EBG 18 is used to improve the performance of inter-antenna isolation.

With the antenna apparatus 100, the distance d₀ between a radiator 12 (referring to the radiator 12a or radiator 12b, whichever is applicable) and the ground electrode 15 is set so that the antenna gain is maximized. The length of the via 16 is equal to the distance d₀ between the radiator 12 and the ground electrode 15.

The frequency band of signals to be blocked by the EBG 18 is determined by, for example, the size of the patch 14 and the length of the via 16. Accordingly, if the length of the via 16 is equal to the distance between the radiator 12 and the ground electrode 15, the size of the patch 14 is also uniquely determined. With the antenna apparatus 100, therefore, it is difficult to adjust the length of the via 16 and the size of the patch 14, the via 16 and patch 14 being included in the EBG 18. This lowers degrees of freedom in design.

If, for example, the length of the via 16 is equal to the distance d₀ between the radiator 12 and the ground electrode 15 or it is difficult to allocate an area enough to dispose a plurality of patches 14 between the radiator 12a and the radiator 12b, it is difficult to dispose the EBG 18.

If, for example, degrees of freedom in the design of the size of the patch 14 are low, it is difficult to improve the isolation characteristics by increasing the number of patches 14 to be disposed between the radiator 12a and the radiator 12b to increase the number of unit cells 17 (the number of repetitions).

If, for example, degrees of freedom in the design of the length of the via 16 are low, it is difficult to dispose a wire in an inner layer of the dielectric substrate 11, depending on the length of the via 16.

The present disclosure addresses the above situations by focusing attention on providing a ground electrode to be connected to vias in the EBG separately from conductors that function as reflectors corresponding to radiators.

Next, embodiments of the present disclosure will be described in detail with reference to the drawings. The embodiments described below are just examples. The present disclosure is not limited by these embodiments.

### First Embodiment

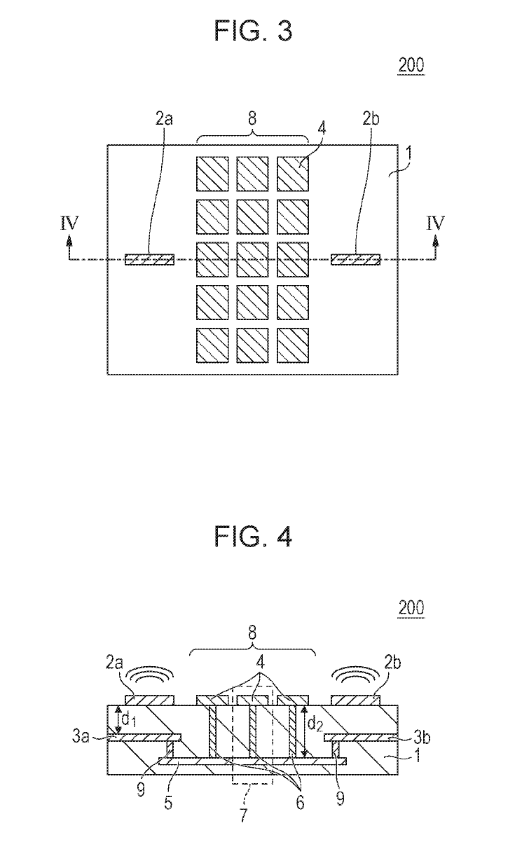

FIG. 3 is a top view illustrating an example of an antenna apparatus 200 according to a first embodiment. FIG. 4 is a cross-sectional view taken along line IV-IV in FIG. 3.

The antenna apparatus 200 has a dielectric substrate 1, radiators 2 (radiator 2a and radiator 2b), reflectors 3 (reflector 3a and reflector 3b), a ground electrode 5, and an EBG 8.

The radiator 2a and radiator 2b are formed on the front surface of the dielectric substrate 1 by using conductive patterns.

The reflector 3a and reflector 3b are formed on the plane of an inner layer of the dielectric substrate 1 by using a conductive pattern. The reflector 3a is formed in a range that includes a range in which the radiator 2a is projected to an inner-layer plane. The reflector 3b is formed in a range that includes a range in which the radiator 2b is projected to the inner-layer plane.

A combination of the radiator 2a and reflector 3a and a combination of the radiator 2b and reflector 3b each function as a single antenna.

The ground electrode 5 is formed by using a conductive pattern on a plane of an inner layer that differs from the inner layer in which the reflector 3a and reflector 3b are formed. In the example in FIG. 4, the inner-layer plane on which the ground electrode 5 is formed is more away from the surface layer than the inner-layer plane on which the reflector 3a and reflector 3b are formed. The ground electrode 5 is connected to the reflector 3a and reflector 3b through vias 9.

The EBG 8 is disposed between the radiator 2a and the radiator 2b. The EBG 8 includes a plurality of patches 4 (for example, 15 patches 4 in FIGS. 3 and 4) formed on the surface layer and also includes a plurality of vias 6 (for example, 15 vias 6 in FIGS. 3 and 4), each of which mutually connects one patch 4 and the ground electrode 5. The length of the via 6 is the distance d₂ between the relevant patch 4 and the ground electrode 5.

The EBG 8 is formed by periodically placing unit cells 7, each of which is a combination of the ground electrode 5, one via 6 connected to the ground electrode 5, and the patch 4 corresponding to the via 6. This type of EBG 8 formed from periodically disposed unit cells 7, each of which is composed of one patch 4, one via 6, and the ground electrode 5, is referred to as a mushroom-type EBG.

The distance d₁ between the radiator 2a and the reflector 3a is determined so that the antenna gain is maximized. Since the ground electrode 5 is formed on an inner-layer plane different from the inner-layer plane on which the reflector 3a and reflector 3b are formed, the distance d₂, equivalent to the length of the via 6, between the patch 4 and the ground electrode 5 is adjusted independently of the distance d₁. With the antenna apparatus 200, the inner-layer plane on which the ground electrode 5 is formed is more away from the surface layer than the inner-layer plane on which the reflector 3a and reflector 3b are formed, so the distance d₁ is shorter than the distance d₂.

Since, in this structure, the distance d₁ between the radiator 2 and the reflector 3 and the distance d₂ equivalent to the length of the via 6 can be adjusted separately, it is possible to improve degrees of freedom in the design of the antenna apparatus 200 including the EBG 8.

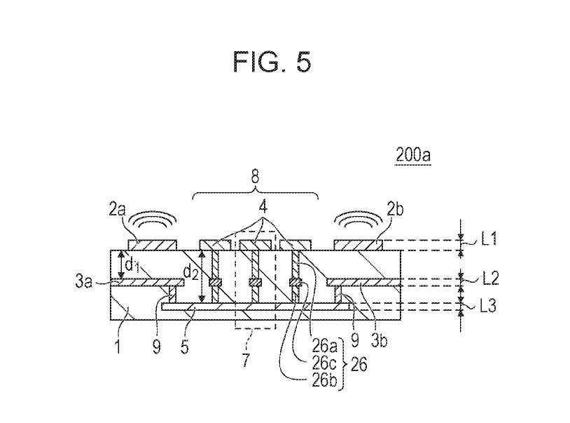

A via that mutually connects the patch 4 and ground electrode 5 may be a single via 6 as illustrated in FIG. 4 or may be a stack via 26 formed by combining a via 26a and a via 26b that are formed in different inner layers as illustrated in FIG. 5. An antenna apparatus having stack vias 26 will be described below.

FIG. 5 is a cross-sectional view illustrating an example of an antenna apparatus 200a having stack vias 26. In FIG. 5, the same elements as in FIGS. 3 and 4 are denoted by the same reference characters, and their repeated descriptions will be omitted. An L1 layer, an L2 layer, and an L3 layer described below each indicate a wiring layer in the antenna apparatus 200a.

In FIG. 5, a plane of the dielectric substrate 1 on which the radiators 2a and 2b are disposed will be referred to as the L1 layer, a plane of the dielectric substrate 1 on which the reflectors 3a and 3b are disposed will be referred to as the L2 layer, and a plane of the dielectric substrate 1 on which the ground electrode 5 is disposed will be referred to as the L3 layer.

Each stack via 26 mutually connects one patch 4 and the ground electrode 5. The stack via 26 has, for example, a first via 26a, a second via 26b, and a first connecting part 26c.

The first via 26a is positioned between the L1 layer and the L2 layer, the first connecting part 26c is positioned in the L2 layer, and the second via 26b is positioned between the L2 layer and the L3 layer. Although, in the example in FIG. 5, the stack via 26 is composed of two vias and one connecting part, the number of vias and the number of connection parts are not limited to this example. Although, for example, the first via 26a is formed between the L1 layer and the L2 layer, a third via and a second connecting part (not illustrated) may be added.

Due to the structured described above, the distance d₁ between the radiator 2 and the reflector 3 and the distance d₂ equivalent to the length of the via 6 or stack via 26 can be adjusted separately, it is possible to improve degrees of freedom in the design of the antenna apparatus 200a including the EBG 8.

Next, an example of a relationship between the size of the EBG 8 including the distance d₂ and the frequency band of signals to be blocked by the EBG 8 will be described. As described above, the frequency band of signals to be blocked by the EBG 8 is determined by, for example, the size of the patch 4 and the length of the via 6.

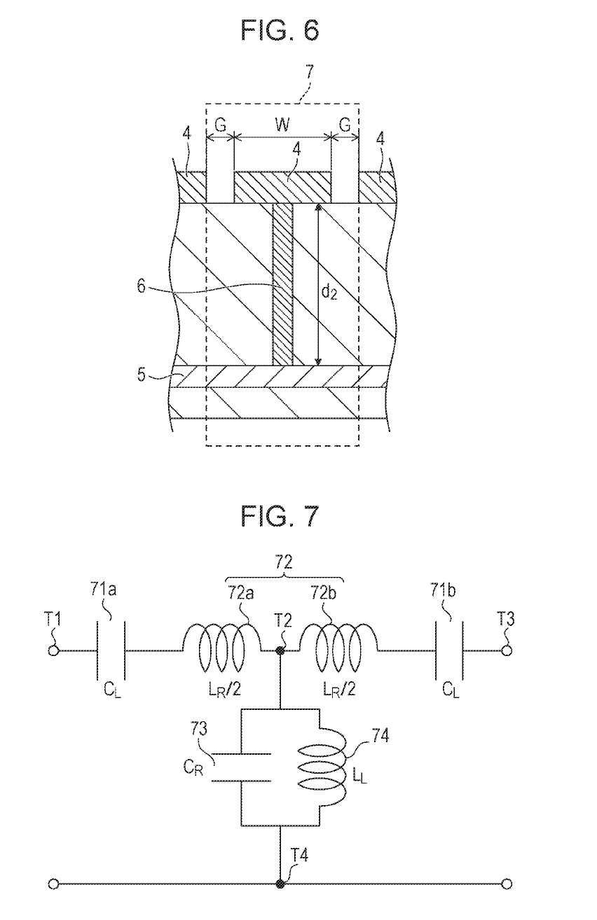

FIG. 6 is an enlarged view the unit cell 7 in the EBG 8. FIG. 7 illustrates an equivalent circuit of the unit cell 7 in the EBG8. As illustrated in FIG. 6, the patch 4 has a width W and two adjacent patches 4 are disposed with a gap G between them.

Capacitors 71a and 71b in FIG. 7, each of which has a capacitance C_{L}, equivalently indicate a capacitance between two adjacent patches 4 spaced by the gap G on the surface layer. Inductors 72a and 72b each have an inductance L_{R}/2. An inductor 72 including the inductors 72a and 72b equivalently indicates an inductor in the patch 4. The capacitor 71a and inductor 72a are equivalently connected in series between a terminal T1 and a terminal T2. The inductor 72b and capacitor 71b are equivalently connected in series between the terminal T2 and a terminal T3.

A capacitor 73 in FIG. 7, which has a capacitance C_{R}, equivalently indicates a capacitance between the patch 4 and the ground electrode 5 spaced by the distance d₂. An inductor 74 in FIG. 7, which has an inductance L_{L}, equivalently indicates an inductance in the via 6. The capacitor 73 and inductor 74 are equivalently connected in parallel between the terminal T2 and a terminal T4.

In circuit analysis based on the assumption that the unit cell 7 is repeatedly disposed infinitely and periodically, the frequency band of signals to be blocked by the EBG 8 is determined by using equation (1) below represented by the capacitors 71a and 71b and inductors 72a and 72b that are connected in series in an equivalent circuit and/or equation (2) below represented by the capacitor 73 and inductor 74 that are connected in parallel in an equivalent circuit, as described in, for example, Atsushi Sanada, Christophe Caloz, Tatsuo Itoh, “Planar Distributed Structures with Negative Reflective Index”, IEEE Transactions on Microwave Theory and Techniques, vol. 52, No. 4, pp. 1252-1263, (Apr. 13, 2004).

$$\begin{matrix}{ω}_{se} = \frac{1}{\sqrt{{L}_{R} {C}_{L}}} & ( 1 ) \\ {ω}_{sh} = \frac{1}{\sqrt{{L}_{L} {C}_{R}}} & ( 2 )\end{matrix}$$

In the above equations, ωₛₑ and ωₛₕ indicate the upper limit or lower limit of the frequency band of signals to be blocked by the EBG 8. If equations (1) and (2) indicate that the product of L_{R} and C_{L} (referred to below as the L_{R}C_{S} product) is constant and that the product of L_{L} and C_{R} (referred to below as the L_{L}C_{R} product) is also constant, even if the size (width W of the patch 4 and/or length d₂ of the via 6, for example) of the unit cell 7 is adjusted, the frequency band of signals to be blocked by the EBG 8 remains unchanged.

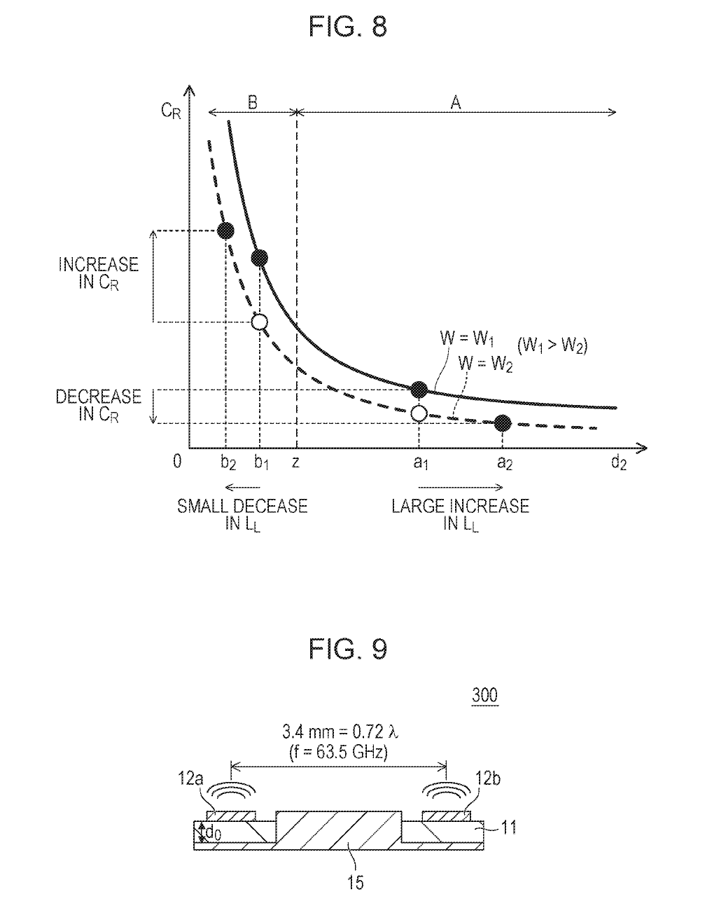

An area occupied by the EBG 8, for example, is determined by the area of the patch 4, so the occupied area can be reduced by reducing the width W of the patch 4. When the width W is reduced, the capacitance C_{R} is equivalently reduced. To make the L_{L}C_{R} product constant, it suffices to increase the inductance L_{L} by prolonging the distance d₂, that is, the length of the via 6, by an amount by which the capacitance C_{R} has been reduced. If the distance d₂ is equal to or shorter than a predetermined value z, the L_{L}C_{R} product may be made constant by reducing the width W and then shortening the length d₂ of the via 6. A specific example of making the L_{L}C_{R} product constant will be described below with reference to FIG. 8.

FIG. 8 illustrates a relationship between the distance d₂ and the capacitance C_{R}. In FIG. 8, the horizontal axis indicates the distance d₂ and vertical axis indicates the capacitance C_{R}. The distance d₂ and capacitance C_{R} in FIG. 8 have a substantially inversely proportional relationship. For convenience of explanation, a plurality of typical values of the distance d₂ are indicated in FIG. 8; these values are larger than 0, and a₂ is largest, followed by a₁, z, b₁, and b₂ in that order. For convenience of explanation, in FIG. 8, an area A and an area B are defined with d₂ at z taken as a boundary between them. Specifically, a range in which d₂ is larger z is defined as the area A, and a range in which d₂ is larger than 0 and is smaller than z is defined as the area B. FIG. 8 also illustrates a curve indicating a relationship between the distance d₂ and the capacitance C_{R} when the width W is W₁ (the curve, indicated by a solid line, will be referred to below as the curve K_{w1}), and a curve indicating a relationship between the distance d₂ and the capacitance C_{R} when the width W is W₂ (the curve, indicated by a dashed line, will be referred to below as the curve K_{w2}), being larger than W₂. The capacitance C_{R} on the curve K_{w1} is larger than on the curve K_{w2} over the entire area of the distance d₂.

When the width W is reduced, the capacitance C_{R} indicated by the curve K_{w1} and curve K_{w2} changes differently between the area A and the area B.

When, for example, the value of the width W is reduced from W₁ to W₂ in the area A, the capacitance C_{R} is reduced. In this case, to keep the L_{L}C_{R} product constant, the value of the distance d₂ is increased from a₁ to a₂ (that is, the length of the via 6 is increased) to increase the inductance L_{L}.

When the value of the width W is reduced from W₁ to W₂ in the area B, the capacitance C_{R} is reduced. However, the capacitance C_{R} can be increased by reducing the value of the distance d₂ from b₁ to b₂. In the area B, therefore, when the width W is reduced, the L_{L}C_{R} product may be kept constant by reducing the distance d₂.

Alternatively, to keep the L_{R}C_{S} product, the gap G may be adjusted.

Since the size of the EBG 8 including the distance d₂ of the via 6 and the width W of the patch 4 can be adjusted while the frequency band of signals to be blocked by the EBG 8 is maintained, as described above, degrees of freedom in the design of the antenna apparatus 200 including the EBG 8 are increased.

Next, the inter-antenna isolation characteristics of an antenna apparatus will be described. The inter-antenna isolation characteristics described below as an example assume that the antenna apparatus radiates electromagnetic waves at a frequency of 63.5 GHz and the EBG blocks signals in a frequency band including the 63.5-GHz frequency. First, an example of an antenna apparatus that lacks an EBG will be described.

FIG. 9 is a cross-sectional view of an antenna apparatus 300 that lacks an EBG. In FIG. 9, the same elements as in FIG. 1 are denoted by the same reference characters, and their repeated descriptions will be omitted. The antenna apparatus 300 differs from the antenna apparatus 100 illustrated in FIGS. 1 and 2 in that the ground electrode 15 between the radiator 12a and the radiator 12b extends to the surface layer instead of using the EBG 18.

The radiator 12a and radiator 12b are each a dipole radiator 12. The distance between the radiator 12a and the radiator 12b is set to a length of 3.4 mm obtained by multiplying the wavelength λ of a 63.5-GHz frequency f by 0.72. The distance between the radiator 12a and the ground electrode 15 and the distance between the radiator 12b and the ground electrode 15 are set so that the antenna gain is maximized when the antenna apparatus 300 radiates microwaves at the 63.5-GHz frequency.

Next, isolation characteristics obtained by simulation will be compared among the antenna apparatus 300 that lacks an EBG, the conventional antenna apparatus 100 having an EBG, and the antenna apparatus 200 having an EBG that occupies a less area.

The antenna apparatus 100, which has been used as a simulation model, has the radiator 12a and radiator 12b as in the antenna apparatus 300. With the antenna apparatus 100, the distance between the radiator 12a and the radiator 12b, and the distance d₀ between the radiator 12a and the ground electrode 15, and the distance d₀ between the radiator 12b and the ground electrode 15 are also the same as in the antenna apparatus 300. The length of one edge of the patch 14 in the EBG 18 included in the antenna apparatus 100 is set to 0.45 mm.

The radiator 2a and radiator 2b in the antenna apparatus 200 used as the simulation model are each a dipole radiator 2 as in the antenna apparatus 300. The distance between the radiator 2a and the radiator 2b is set to 3.4 mm as in the antenna apparatus 300. The distance between the radiator 2a and the reflector 3a and the distance between the radiator 2b and the reflector 3b are equal to the distance between the radiator 12a and the ground electrode 15 in the antenna apparatus 300. The length of one edge of the patch 4 in the EBG 8 included in the antenna apparatus 200 is set to 0.35 mm. The length of the via 6 is set according to the length of one edge of the patch 4 so that the EBG 8 blocks signals at the 63.5-GHz frequency.

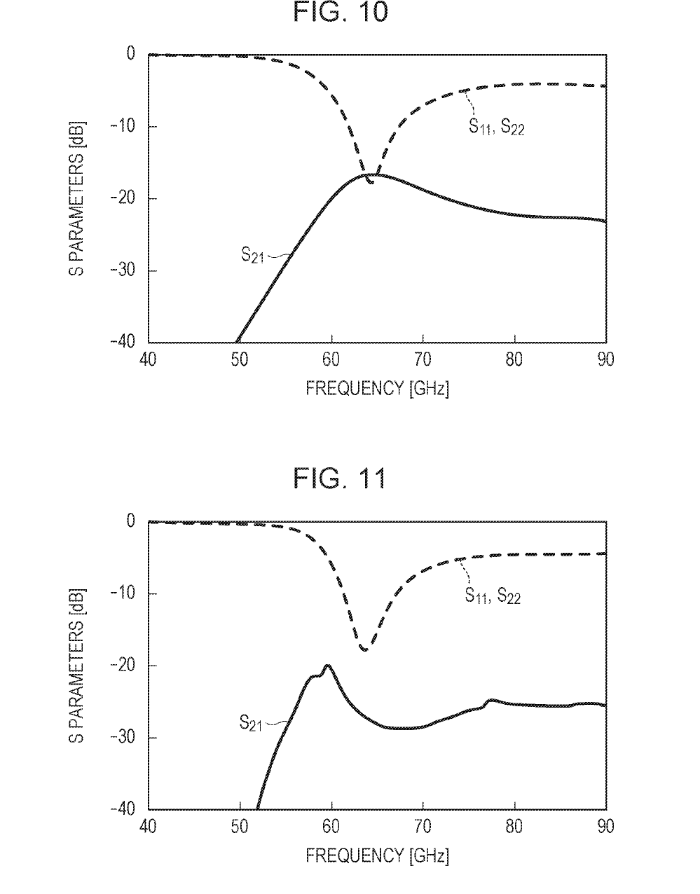

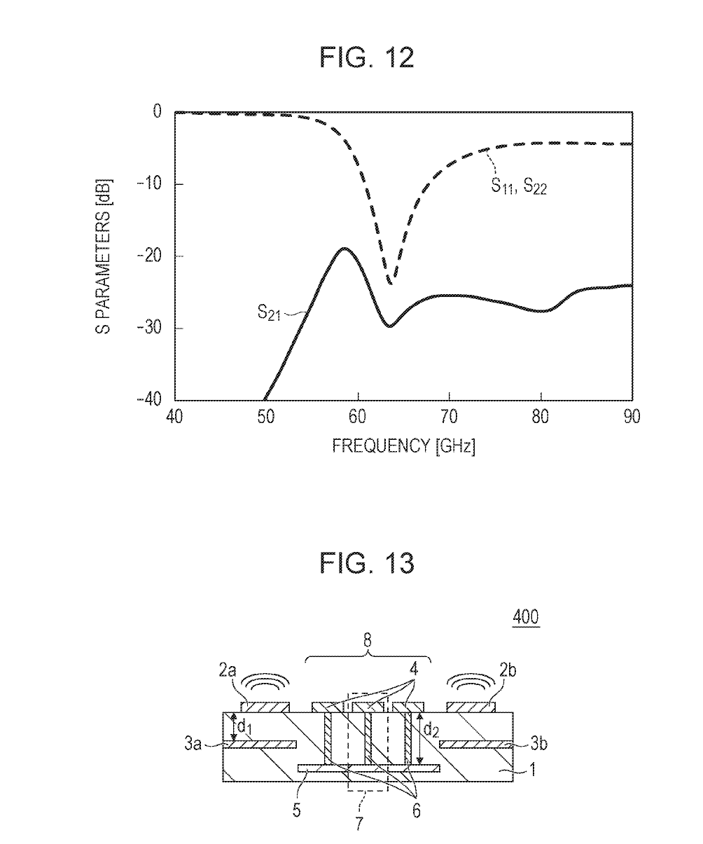

FIG. 10 illustrates the isolation characteristics of the antenna apparatus 300 that lacks an EBG. FIG. 11 illustrates the isolation characteristics of the conventional antenna apparatus 100 having an EBG. FIG. 12 illustrates the isolation characteristics of the antenna apparatus 200 according to the first embodiment of the present disclosure. In FIGS. 10 to 12, the horizontal axis indicates the frequency of an electromagnetic wave radiated by the relevant antenna apparatus and the vertical axis indicates the values of S parameters (S₁₁, S₂₂, and S₂₁). S₁₁ and S₂₂ are S parameters representing reflection characteristics; the smaller the values of S₁₁ and S₂₂ are, the less reflection is, indicating that the antennas cause resonance. S₂₁ is an S parameter representing transmission characteristics; the smaller the value of S₂₁ is, the higher the inter-antenna isolation characteristics are.

S₁₁ and S₂₂ in FIGS. 10 to 12 indicate that, at frequencies around 63.5 GHz, resonance occurs in all antenna apparatuses. S₂₁ equivalent to inter-antenna isolation characteristics is about −16.9 dB at frequencies around 63.5 GHz in the antenna apparatus 300 that lacks an EBG, about −27.0 dB at frequencies around 63.5 GHz in the antenna apparatus 100, and about −29.6 dB at frequencies around 63.5 GHz in the antenna apparatus 200. Thus, when the EBG 8 was disposed, the isolation characteristics were improved about 10 dB. With the antenna apparatus 200 according to the first embodiment, the area occupied by the EBG 8 could be reduced while the isolation characteristics were assured.

As described above, in the simulation model, the length of one edge of the patch 4 in the antenna apparatus 200 according to the first embodiment is 0.35 mm. By comparison, the length of one edge of the patch 14 in the conventional antenna apparatus 100 is 0.45 mm. That is, with the antenna apparatus 200 in the first embodiment, isolation characteristics can be improved by the use of the EBG 8 and the area occupied by the EBG 8 can be reduced when compared with the conventional antenna apparatus 100. Since the area occupied by the EBG 8 can be reduced, even if the distance between the radiator 2a and the radiator 2b is short, the EBG 8 can be disposed in the antenna apparatus 200.

The simulation model described above is just an example. The present disclosure is not limited to this example. Although, for example, a dipole radiator has been described as a radiator, a radiator having another shape may be used if the radiator can be disposed on a flat surface. For example, a patch antenna may be used instead of the above-described antenna which has the dipole radiator.

With the antenna apparatus 200, an example has been described in which the length (distance d₂) of the via 6 is longer than the distance between the radiator 2a and the reflector 3a and the distance (distance d₁) between the radiator 2b and the reflector 3b. However, the length (distance d₂) of the via 6 may be shorter than the distance between the radiator 2a and the reflector 3a and the distance (distance d₁) between the radiator 2b and the reflector 3b.

An example has been also described in which the distance between the radiator 2a and the reflector 3a and the distance (distance d₁) between the radiator 2b and the reflector 3b are equal. However, the distance between the radiator 2a and the reflector 3a and the distance between the radiator 2b and the reflector 3b may be different from each other.

As described above, the antenna apparatus 200 in the first embodiment has the dielectric substrate 1, the radiator 2a and radiator 2b disposed in a first wiring layer included in the dielectric substrate 1, the reflector 3a disposed in a range in a second wiring layer included in the dielectric substrate 1, the range including a range in which the radiator 2a is projected in the layer thickness direction of the dielectric substrate 1, the reflector 3b disposed in a range in the second wiring layer, the range including a position opposite to the radiator 2a in the layer thickness direction, and the EBG 8 disposed between the radiator 2a and the radiator 2b. The EBG 8 has patches 4 disposed in the first wiring layer, vias 6 extending in the layer thickness direction, each via 6 being connected to one patch 4, and the ground electrode 5 connected to the vias 6, the ground electrode 5 being disposed in a third wiring layer different from the second wiring layer.

In this structure, the ground electrode connected to the vias in the EBG is disposed in a different layer from the layer in which reflectors corresponding to the radiators are disposed, and the length of the via in the EBG can be adjusted separately from the distance between the radiator and the reflector. Therefore, degrees of freedom in the design of the antenna apparatus are improved.

For example, the size of the patch 4 can be reduced by prolonging the via 6, so even if the distance between the radiator 2a and the radiator 2b is short, the EBG 8 can be disposed between the radiator 2a and the radiator 2b.

In another example in which the size of the patch 4 can be reduced by prolonging the via 6, the number of patches 4 to be disposed between the radiator 2a and the radiator 2b can be increased. Therefore, the number of unit cells 7 (the number of repetitions) in the EBG 8 can be increased, so the inter-antenna isolation characteristics can be more improved.

If, for example, the distance between the radiator 2a and the radiator 2b is relatively long, the via 6 can be shortened by enlarging the size of the patch 4. Therefore, a wire can be disposed in an inner layer below the ground electrode 5 in the dielectric substrate 1.

With the antenna apparatus 200 according to the first embodiment, an example has been described in which the reflector 3a and reflector 3b are connected to the ground electrode 5 through vias 9. The present disclosure is not limited to this example. There may be no connection between the ground electrode 5 and the reflector 3a nor between the ground electrode 5 and the reflector 3b.

FIG. 13 is a cross-sectional view illustrating an example of an antenna apparatus 400 according to a variation of the first embodiment. In FIG. 13, the same elements as in FIGS. 3 and 4 are denoted by the same reference characters, and their repeated descriptions will be omitted. The top view of the antenna apparatus 400 is similar to the top view of the antenna apparatus 200 illustrated in FIG. 3. FIG. 13 is equivalent to the cross-sectional view, in FIG. 3, taken along line IV-IV.

The antenna apparatus 400 differs from the antenna apparatus 200 in that vias 9 are omitted. Even in this structure, the reflector 3a and reflector 3b have a function that reflects an electromagnetic wave radiated respectively from the radiator 2a and radiator 2b. The antenna apparatus 400 has effects similar to those provided by the antenna apparatus 200.

In the first embodiment and its variation, an example has been described in which two radiators and two reflectors, each of which is paired with one of the two radiators, are disposed. The present disclosure is not limited to this example. The number of radiators may be 3 or more and there may be two or more radiator pairs, each of which is composed of two radiators. In this case, the number of reflectors is also increased according to the increased number of radiators.

In the antenna apparatus 200 and antenna apparatus 400, the ground electrode 5 may be disposed in the layer in which the radiators 2a and 2b and the patches 4 are included, so as to be in the vicinity of the radiators 2a and 2b and patches 4.

### Second Embodiment

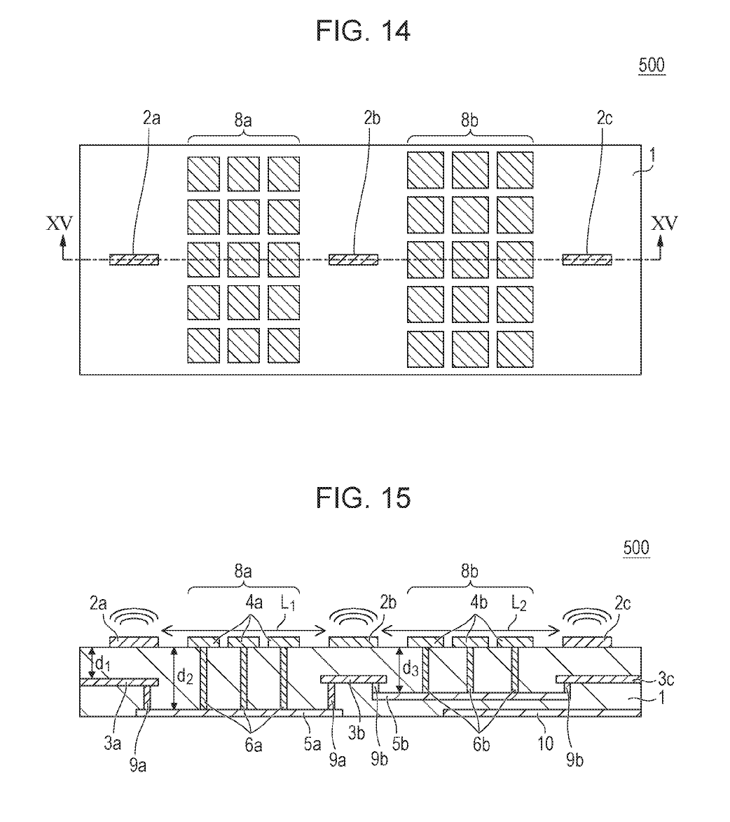

FIG. 14 is a top view illustrating an example of an antenna apparatus 500 according to a second embodiment of the present disclosure. FIG. 15 is a cross-sectional view taken along line XV-XV in FIG. 14. In FIGS. 14 and 15, the same elements as in FIGS. 3 and 4 are denoted by the same reference characters, and their repeated descriptions will be omitted.

The antenna apparatus 500 has the dielectric substrate 1, radiators 2 (radiator 2a, radiator 2b, and radiator 2c), reflectors 3 (reflector 3a, reflector 3b, and reflector 3c), a ground electrode 5a, a ground electrode 5b, an EBG 8a, an EBG 8b, and a wire 10.

The radiator 2a, radiator 2b, and radiator 2c are formed on the front surface of the dielectric substrate 1 by using conductive patterns. The distance between the radiator 2a and radiator 2b is L₁, and the distance between the radiator 2b and the radiator 2c is L₂, which is larger than L₁.

The reflector 3a, reflector 3b, and reflector 3c are formed on an inner-layer plane in the dielectric substrate 1 by using conductive patterns. The reflector 3a is formed in a range that includes a range in which the radiator 2a is projected to an inner-layer plane. The reflector 3b is formed in a range that includes a range in which the radiator 2b is projected to an inner-layer plane. The reflector 3c is formed in a range that includes a range in which the radiator 2c is projected to an inner-layer plane.

A combination of the radiator 2a and reflector 3a, a combination of the radiator 2b and reflector 3b, a combination of the radiator 2c and reflector 3c each function as a single antenna.

The ground electrode 5a is formed by using a conductive pattern on a plane of an inner layer that differs from the inner layer on which the reflector 3a, reflector 3b, and reflector 3c are formed. In the example in FIG. 15, the inner-layer plane on which the ground electrode 5a is formed is more away from the surface layer than the inner-layer plane on which the reflector 3a, reflector 3b, and reflector 3c are formed; the inner-layer plane on which the ground electrode 5a is formed is d₂ away from the surface layer. The ground electrode 5a is connected to the reflector 3a and reflector 3b through vias 9a.

The ground electrode 5b is formed by using a conductive pattern on a plane of an inner layer that differs from the inner layer on which the reflector 3a, reflector 3b, and reflector 3c are formed. In the example in FIG. 15, the inner-layer plane on which the ground electrode 5b is formed is more away from the surface layer than the inner-layer plane on which the reflector 3a, reflector 3b, and reflector 3c are formed; the inner-layer plane on which the ground electrode 5b is formed is d₃ away from the surface layer. The ground electrode 5b is connected to the reflector 3b and reflector 3c through vias 9b.

The inner layer in which the ground electrode 5b is formed differs from the inner layer in which the ground electrode 5a is formed.

The EBG 8a is disposed between the radiator 2a and the radiator 2b. The EBG 8a includes a plurality of patches 4a formed on the surface layer and also includes a plurality of vias 6a, each of which mutually connects one patch 4a and the ground electrode 5a. The length of the via 6a is the distance d₂ between the relevant patch 4a and the ground electrode 5a.

The EBG 8b is disposed between the radiator 2b and the radiator 2c. The EBG 8b includes a plurality of patches 4b formed on the surface layer and also includes a plurality of vias 6b, each of which mutually connects one patch 4b and the ground electrode 5b. The length of the via 6b is the distance d₃ between the relevant patch 4b and the ground electrode 5b.

The distance d₁ between the radiator 2 and the reflector 3 is determined so that the antenna gain is maximized. Since the distance L₂ between the radiator 2b and the radiator 2c is longer than the distance L₁ between the radiator 2a and the radiator 2b, the distance d₃ between the patch 4b and the ground electrode 5b can be set so as to be shorter than the distance d₂ between the patch 4a and the ground electrode 5a. Accordingly, the wire 10 can be formed in a layer disposed opposite to the surface layer with respect to the ground electrode 5b.

Since, in this structure, the distance d₁, distance d₂, and distance d₃ can be adjusted separately, degrees of freedom in the design of the antenna apparatus 500 including the EBG 8a and EBG 8b are higher than degrees of freedom in the design of the antenna apparatus 200 including the EBG 8. For example, it is possible to adjust the size of the patch 4 and/or the length of the via 6, the patch 4 and via 6 being in the EBG 8 disposed between radiators 2, according to the distance between the radiators 2.

In FIGS. 14 and 15, for example, the length of the via 6b can be shortened by enlarging the size of the patch 4b in the EBG 8b disposed between the radiator 2b and the radiator 2c, the distance between which is relatively long. Therefore, the ground electrode 5b connected to the vias 6b can be brought close to the surface layer. As a result, a space in which to form the wire 10 can be provided below the ground electrode 5b.

With the antenna apparatus 500 according to the second embodiment, an example has been described in which the ground electrode 5 and reflector 3 are mutually connected through the via 9 has been described. However, the present disclosure is not limited to this example. The ground electrode 5 and reflector 3 may not be mutually connected. However, the ground electrode 5a and ground electrode 5b are mutually connected electrically.

With the antenna apparatus 500 according to the second embodiment, an example has been described in which three radiators 2 and three reflectors 3, each of which is paired with one of the three radiators 2, are aligned. The present disclosure is not limited to this example. The number of radiators 2 may be 4 or more and there may be two or more radiator pairs, each of which is composed of two radiators 2. In this case, the number of reflectors 3 is also increased according to the increased number of radiators 2.

In the antenna apparatus 500, the ground electrode 5 disposed in the layer in which the radiators 2a, 2b and 2c and the patches 4a and 4b are included may be present in the vicinity of the radiators 2a, 2b and 2c and the patches 4a and 4b.

The sizes, distances, and other numerical values indicated in the above embodiments are just examples. The present disclosure is not limited to these examples.

So far, embodiments have been described with reference to the drawings. However, it will be appreciated that the present disclosure is not limited to these embodiments. It is apparent that persons having ordinary skill in the art can devise various examples of variations and various examples of corrections, without departing from the intended scope of the claims of the present disclosure. It will be understood that these examples are of course included in the technical range of the present disclosure. Various constituent elements in the above embodiments may be arbitrarily combined, without departing from the intended scope of the present disclosure.

### Compilation in the Present Disclosure

An antenna apparatus in the present disclosure has: a dielectric substrate; at least a first radiator and a second radiator that are disposed in a first wiring layer included in the dielectric substrate; a first reflector disposed in a first range in a second wiring layer included in the dielectric substrate, the first range including a second range in which the first radiator is projected in the layer thickness direction of the dielectric substrate; a second reflector disposed in a third range in the second wiring layer, the third range including a fourth range in which the second radiator is projected in the layer thickness direction; and a first electromagnetic band-gap disposed between the first radiator and the second radiator. The first electromagnetic band-gap has first patches disposed in the first wiring layer, a first ground electrode disposed in a third wiring layer disposed at a different place from the second wiring layer in the layer thickness direction of the dielectric substrate, and first vias extending in the layer thickness direction, both ends of the first via mutually connecting the first patches and the first ground electrode.

In the antenna apparatus in the present disclosure, the first radiator and the first reflector constitute a first antenna, the second radiator and the second reflector constitute a second antenna, and the first electromagnetic band-gap is designed to block signals in a frequency range including a resonant frequency of the first antenna and the second antenna.

In the antenna apparatus in the present disclosure, the distance between the first wiring layer and the third wiring layer is longer than the distance between the first wiring layer and the second wiring layer.

In the antenna apparatus in the present disclosure, the longer the distance between the first wiring layer and the second wiring layer is, the more the size of the first patch is enlarged and the more a distance between the first wiring layer and the third wiring layer is shortened.

The antenna apparatus in the present disclosure includes a third radiator disposed in the first wiring layer, a third reflector disposed in a fifth range in the second wiring layer, the fifth range including a sixth range opposite to the third radiator in the layer thickness direction, and a second electromagnetic band-gap disposed between the second radiator and the third radiator. The second electromagnetic band-gap has second patches disposed in the first wiring layer, a second ground electrode disposed in a fourth wiring layer disposed at a different place from the second wiring layer and third wiring layer in the layer thickness direction of the dielectric substrate, and second vias extending in the layer thickness direction, both ends of the second vias mutually connecting the second patches and the second ground electrode.

In the antenna apparatus in the present disclosure, the first via is longer than the second via, and a size of the first patch is smaller than the size of the second patch.

The present disclosure can be implemented by software, hardware, or software that works in cooperation with hardware.

Some functional blocks used in the description of the above embodiments may be implemented by an integrated circuit (IC), and part or the whole of each process described in the above embodiments may be controlled by a single IC or a combination of ICs. An IC may be composed of individual chips or may be composed of a single chip so that part or all of the functional blocks are included. An IC may implement data input and data output. An IC may be called a large scale integration (LSI) circuit, a system LSI circuit (or custom LSI circuit), a very large scale integration (VLSI) circuit, an ultra large scale integration (ULSI) circuit, or a wafer scale integration (WSI) circuit, depending on the purpose, the form, and the degree of integration.

An IC may be implemented by a special circuit, a general-purpose processor, or a special processor. Alternatively, a field programmable gate array (FPGA), in which programming is possible after an IC has been manufactured, or a reconfigurable processor, in which the connections and settings of circuit cells in the IC can be reconfigured, may be used. The present disclosure may be implemented as digital processing or analog processing.

Furthermore, if a technology of circuit integration appears as a substitution for conventional ICs and LSI circuits due to advanced semiconductor technology or another technology derived from semiconductor technology, the technology may be of course used to integrate functional blocks. Application of bio-technology may be possible.

The present disclosure can be applied to radars that operate at frequencies in a millimeter wave band or terahertz band or to wireless communication modules for use in communication and other applications.

What is claimed is:

1. An antenna apparatus comprising:
a dielectric substrate;
at least a first radiator and a second radiator that are disposed in a first wiring layer included in the dielectric substrate;
a first reflector disposed in a first range in a second wiring layer included in the dielectric substrate, the first range including a second range in which the first radiator is projected in a layer thickness direction of the dielectric substrate;
a second reflector disposed in a third range in the second wiring layer, the third range including a fourth range in which the second radiator is projected in the layer thickness direction; and
a first electromagnetic band-gap disposed between the first radiator and the second radiator; wherein
the first electromagnetic band-gap has
a first patch disposed in the first wiring layer,
a first ground electrode disposed in a third wiring layer disposed at a different place from the second wiring layer in the layer thickness direction of the dielectric substrate, and
a first via extending in the layer thickness direction, both ends of the first via mutually connecting the first patch and the first ground electrode.

2. The antenna apparatus according to claim 1, wherein:
the first radiator and the first reflector constitute a first antenna;
the second radiator and the second reflector constitute a second antenna; and
the first electromagnetic band-gap is designed to block a signal in a frequency range including a resonant frequency of the first antenna and the second antenna.

3. The antenna apparatus according to claim 1, wherein a distance between the first wiring layer and the third wiring layer is longer than a distance between the first wiring layer and the second wiring layer.

4. The antenna apparatus according to claim 1, wherein the longer a distance between the first wiring layer and the second wiring layer is, the more a size of the first patch is enlarged and the more a distance between the first wiring layer and the third wiring layer is shortened.

5. The antenna apparatus according to claim 1, further comprising:
a third radiator disposed in the first wiring layer;
a third reflector disposed in a fifth range in the second wiring layer, the fifth range including a sixth range opposite to the third radiator in the layer thickness direction; and
a second electromagnetic band-gap disposed between the second radiator and the third radiator; wherein
the second electromagnetic band-gap has
a second patch disposed in the first wiring layer,
a second ground electrode disposed in a fourth wiring layer disposed at a different place from the second wiring layer and the third wiring layer in the layer thickness direction of the dielectric substrate, and
a second via extending in the layer thickness direction, both ends of the second vias mutually connecting the second patch and the second ground electrode.

6. The antenna apparatus according to claim 5, wherein:
the first via is longer than the second via; and
a size of the first patch is smaller than a size of the second patch.
